(19) United States
(12) Patent Application Publication
(10) Pub. No.: US 2026/0267540 A1
(43) Pub. Date: Sep. 10, 2026

(54) ONE-TIME PROGRAMMABLE MEMORY POWER MONITOR

(71) Applicant: Mobileye Vision Technologies Ltd., Jerusalem (IL)

(72) Inventors: Herbert LIONDAS, Zikhron Ya'akov (IL); Michael BONN, Netanya (IL)

(21) Appl. No.: 19/561,592

(22) Filed: Mar. 10, 2026

(30) Foreign Application Priority Data
Mar. 10, 2025 (DE) 10 2025 108 844

(51) Int. Cl. G06F 3/06

(52) U.S. Cl. CPC G06F 3/0625; G06F 3/0653; G06F 3/0673

(57) ABSTRACT

A device includes a one-time programmable memory, electrically conductively connected to a voltage source; and a voltage monitor, electrically conductively connected to the voltage source, and configured to detect a voltage of the voltage source; cause the one-time programmable memory to operate according to a first operational mode when the detected voltage is above a first predetermined threshold; and cause the one-time programmable memory to operate according to a second operational mode when the detected voltage is below a second predetermined threshold.

### CROSS-REFERENCE TO RELATED APPLICATIONS

This application claims priority to German patent application 102025108844, filed on March 10, 2025, the entire contents of which are incorporated by reference herein.

### TECHNICAL FIELD

Various aspects of this disclosure generally relate to the monitoring of a power supply for a one-time programmable memory.

### BACKGROUND

One-time programmable (OTP) memory is a type of non-volatile (e.g., it retains data even when power is removed) memory that can be programmed only once (e.g., a write-once, read-many memory) and thus cannot generally be erased or reprogrammed after the initial write. OPT memory is typically used for the permanent storage of data, such as encryption keys, firmware, or device configuration settings. It may be of particular use in implementations that require higher levels of security, since its inability to be re-written may hinder or prevent certain tampering efforts.

OTP memory may be standalone memory or may be embedded in chips. It is often programmed during the manufacturing or production process. In programing OTP memory, specific data may be written on the memory, such as, for example, calibration parameters. Alternatively or additionally, OTP memory may store security keys and other security sensitive data.

OTP may be configured to operate with a particular supply voltage. In an exemplary configuration, the supply voltage may be 1.8V, and a supply voltage of 1.8V will be assumed herein for simplification of the disclosure; however, the principles disclosed herein may be applied to OTP memory of any supply voltage. If the OTP memory is configured to use a supply voltage (e.g., voltage at drain (VDD)) at the input/output junction of the memory (e.g., the VDDIO) of 1.8V, but then the supply voltage of the power supply to the OTP memory is reduced, a false zero (e.g., as opposed to an intended one) may be detected. That is, a memory bit that should otherwise yield a high voltage output may be interpreted as yielding a low voltage output, not because of the state of the bit, but instead because the supply voltage is simply too low to render a high signal output. In some circumstances, false zeros may be detected for each bit, which may be interpreted as meaning that the chip is in an OPEN state (e.g., a non-secured state) with all Joint Test Action Group (JTAG) debug and testing interfaces open. In this case, an attacker may gain access to the chip via the JTAG debugging and testing interfaces. Such access may permit the attacker to read security OTP memory secret keys such as master keys or wrapping keys, and to even write or change OTP data, such as by “writing” unwritten bits. The JTAG debugging and testing interfaces may also permit an attacker to read the system memory, underlying codes, and/or to expose algorithms or perform reverse engineering of the chip’s internal configurations, such as by using design for testability (DFT). Such attacks may occur at power-up, such as when the boot hardware reads the security state from OTP memory, or during operation.

Attempts to mitigate this problem have included the introduction of a digital ‘magic word’, wherein, during power-up and before reading the OTP memory security state and keys, the boot machine reads a specific location in the OTP memory with a pre-defined ‘magic word’ pattern. If the pattern is not read correctly, then it might be due to the OTP voltage being reduced for an attack. In this manner, the chip can be configured not to operate unless or until the magic word is read from the OTP memory, which effectively precludes an attack based on a reduced supply voltage upon a power-up operation.

The problem with this approach, however, is that on a new chip, the OTP memory is completely blank, and the ‘magic word’ is also zero. To work around this problem, if this happens on power-up, the system only allows the burning of this ‘magic word’ via JTAG. Nothing else is permitted, and the chip does not boot until the ‘magic word’ is properly read. Nevertheless, there is a risk that if the OTP memory cannot be correctly programmed for any reason, then this strategy may result in the OTP memory being precluded from testing and production flow of the full chip. The other problem with the ‘magic word’ solution is that it only checks the OTP during boot. Since the security engine reads the OTP memory’s keys and data during runtime too, however, the ‘magic word’ strategy does not protect the OTP memory from attack by reducing the supply voltage during runtime, as described above.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a generalized overview of the voltage sensing strategy disclosed herein;

FIG. 2 depicts an exemplary configuration of the one-time programmable memory monitor;

FIG. 3 depicts a first predetermined threshold and a second predetermined threshold for the supply voltage resulting from a hysteresis of the comparator;

FIG. 4 depicts an alternative configuration of the comparator hysteresis according to another exemplary implementation;

FIG. 5 depicts various examples of a one-time programmable memory power drop with a timing requirement;

FIG. 6 depicts an additional representation of a change in comparator signal output based on a change in detected supply voltage; and

FIG. 7 depicts a sample system integration of the one-time programmable memory monitor and the one-time programmable memory.

### DESCRIPTION

The following detailed description refers to the accompanying drawings that show, by way of illustration, exemplary details and embodiments in which aspects of the present disclosure may be practiced.

The word "exemplary" is used herein to mean "serving as an example, instance, or illustration". Any embodiment or design described herein as "exemplary" is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the Examples expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the Examples, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. Unless otherwise stated, references to “memory” included herein may thus be understood as referring to volatile or non-volatile memory, including random access memory (RAM), read-only memory (ROM), flash memory, solid-state storage, magnetic tape, hard disk drive, optical drive, 3D XPointTM, among others, or any combination thereof. Registers, shift registers, processor registers, data buffers, among others, are also embraced herein by the term memory. Where only a one-time programable memory is recited, then the resulting device should be understood to be a one-time programmable memory. The term “software” refers to any type of executable instruction, including firmware.

The present disclosure solves at least the technical problem of improving OTP memory security. An underlying issue arises when a VCC-voltage for a programmed OTP memory falls beneath a particular threshold, which can cause the OTP memory sense amplifier to read the incoming bits read as low or ‘0’. This may be interpreted as the same state as a non-programmed OTP memory, which may result in the chip being placed in a non-secured state, i.e. with its JTAG and testing interfaces open. This problem is mitigated by introducing a voltage monitor, which monitors the VCC of the OTP memory. Should the voltage monitor detect a VCC voltage beneath a predetermined threshold, the voltage monitor will force an action on the chip (e.g. reset of the chip) to cause closing of the JTAG and avoid external access into the chip.

In this strategy for maintaining the integrity of chip security described herein, a sensor (also referred to herein as an OTP voltage power monitor) continuously senses the OTP memory’s supply voltage and generates (e.g., initiates, prompts) chip reset in case of attack (e.g., when a reduction of the supply voltage potentially indicating an attack is detected). Unlike the ‘magic word’ strategy described above, the sensor strategy described herein operates continuously and thus protects against attacks during runtime (e.g., even after power-up or boot). In an exemplary embodiment, this strategy detects the supply voltage from the same rail that provides the supply voltage to the OTP memory. In so doing, it precludes the sensor from relying on other power supplies or reference voltages that could also be hacked. This strategy may be used with any OTP memory technology of any size, regardless of the address location of the sensitive data. It may desirable, for example, to use this strategy in in any chip that contains a security engine with sensitive keys stored in OTP that must be protected (e.g., a radar chip, a light detection and ranging (LiDAR) device, or otherwise).

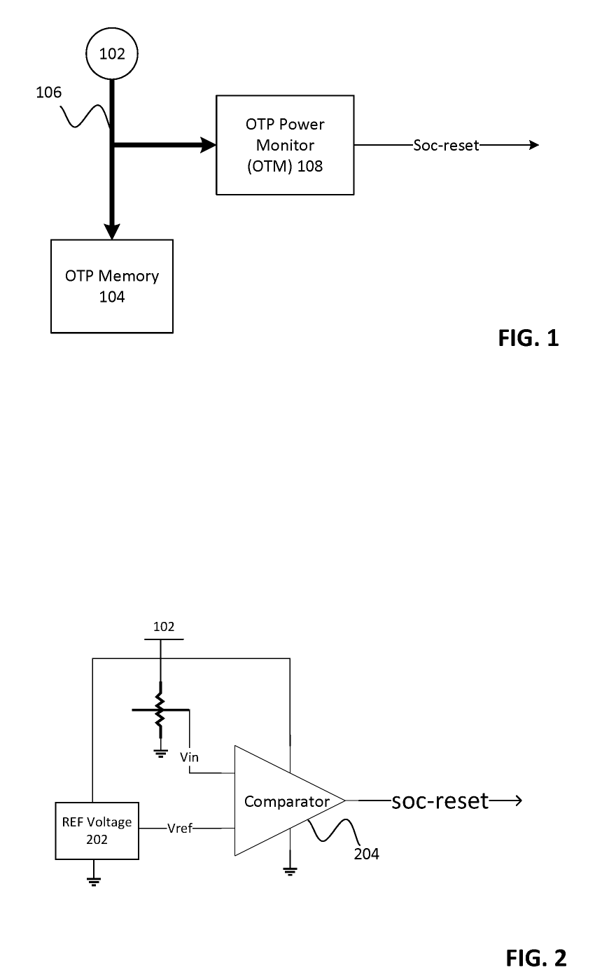

FIG. 1 depicts a generalized overview of the voltage sensing strategy disclosed herein. In this figure, a supply voltage source 102 is configured to provide a supply voltage to an OTP memory 104 along a supply voltage rail 106. An OTP voltage power monitor (OTM) 108 is connected to the supply voltage rail 106 and is configured to monitor a voltage of the supply voltage source 102 along the supply voltage rail 106. The OTM 108 is configured to continuously detect the supply voltage and, based on the detected voltage relative to one of two predetermined thresholds, control the underlying chip to operate according to either a first operational mode or a second operational mode. The instructions (e.g. a signal representing an instruction) to operate according to the first operational mode or the second operational mode may be output from the OTM 108.

FIG. 2 depicts an exemplary configuration of the OTM 108. In this exemplary configuration, the OTM 108 includes a reference voltage generator 202, which is configured to output a reference voltage to an input terminal of a comparator 204. The other input terminal of the comparator is coupled to the supply voltage source 102 of the OTP memory 104. The comparator 204 is configured to compare the supply voltage (corresponding to the supply voltage source 102) with the reference voltage and to generate an output signal (e.g., a high signal or a low signal) representing a result of the comparison. The skilled person will appreciate that the comparator is understood to include a first input and a second input, and whether the supply voltage is connected to the first input and the reference voltage is connected to the second input, or vice versa, is a matter of design or preference. It is also expressly noted that the schematic of FIG. 2 depicts a basic representation of a comparator for simplicity, but this basic representation is not intended to limit the comparator to a particular implementation of being an analog comparator or a digital comparator, or a digital controller or microcontroller that is configured to perform the comparison function; indeed, either an analog or a digital implementation are possible.

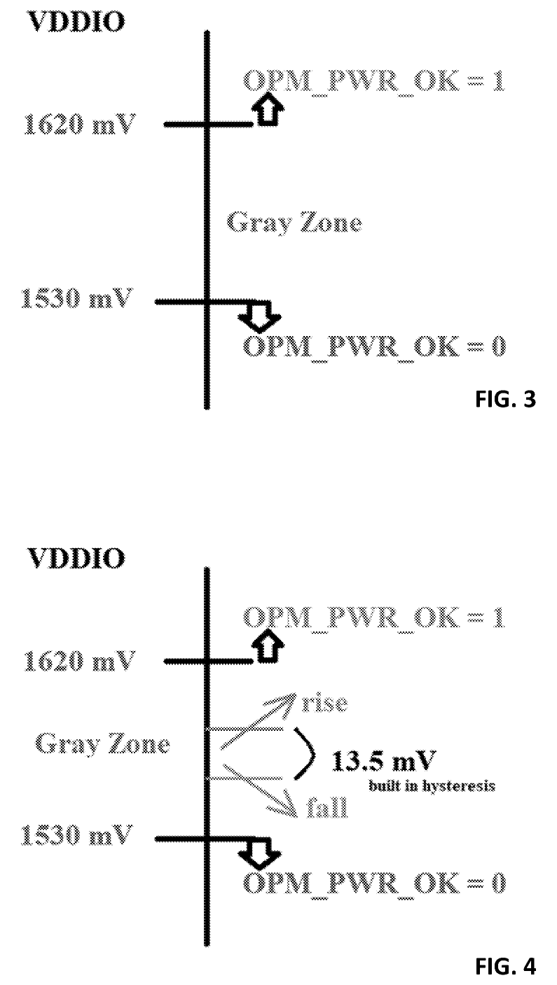

FIG. 3 depicts a first predetermined threshold and a second predetermined threshold resulting from a hysteresis of the comparator for the supply voltage. In this manner, a detected supply voltage beneath the first predetermined threshold (depicted herein in an exemplary configuration as 1530 mV) indicates that the supply voltage is too low and suggests the possibility of an attack. A supply voltage less than this first predetermined threshold should result in a comparator signal output that suggests an attack and, potentially depending on the duration as will be described in greater detail, will prompt a chip reset. The corresponding signal may be understood as a signal to enter the second operational mode. Similarly, a detected supply voltage greater than the second predetermined threshold (depicted herein in an exemplary configuration as 1620 mV) indicates that the supply voltage is satisfactory. A voltage greater than this second predetermined threshold should result in a comparator signal output that suggests normal functioning (e.g., no attack) and which does not prompt a chip reset. The corresponding signal is a signal to enter to remain in the first operational mode.

Notably, this configuration includes a gray zone (depicted as a 90 mV gray zone in this exemplary example). A detected voltage within this gray zone can output with a high signal or a low signal (e.g., a voltage in the gray zone can cause the device to operate in the first operational mode or the second operational mode) depending on the desired configuration. The skilled person will appreciate that it may be possible to configure the comparator without hysteresis, but that this may result in rapid oscillation of the comparator’s output signal when the detected supply voltage approximates the reference voltage, and this rapid oscillation yield unwanted results. Thus, it is anticipated that some level of hysteresis will be desired. The skilled person will appreciate that an analog comparator may be configured to exhibit hysteresis, such as with a feedback to the positive input terminal.

FIG. 4 depicts an alternative configuration of the comparator hysteresis according to another exemplary implementation. In this configuration, the falling threshold to output a low comparator signal (e.g., the first predetermined threshold) and the rising threshold to output a high comparator signal (e.g., the second predetermined threshold) may be arranged so that they exhibit a smaller gap than that of FIG. 3. As an example, the thresholds of FIG. 4 are depicted as being only 13.5 mV apart and thereby also exhibiting only 13.5 mV of gray zone. Other constellations of thresholds are also conceivable and may be selected at will for a given implementation. As an alternative configuration, the falling threshold to output a low comparator signal (e.g., the first predetermined threshold) may range from 1.559 mV to 1.575mV, and the rising threshold to output a high comparator signal (e.g., the second predetermined threshold) may range from 1.573 mV to 1.589mV. Other ranges are also possible, and the skilled person will appreciate how to select such a range, such as based on the desired hysteresis and the underlying supply voltage.

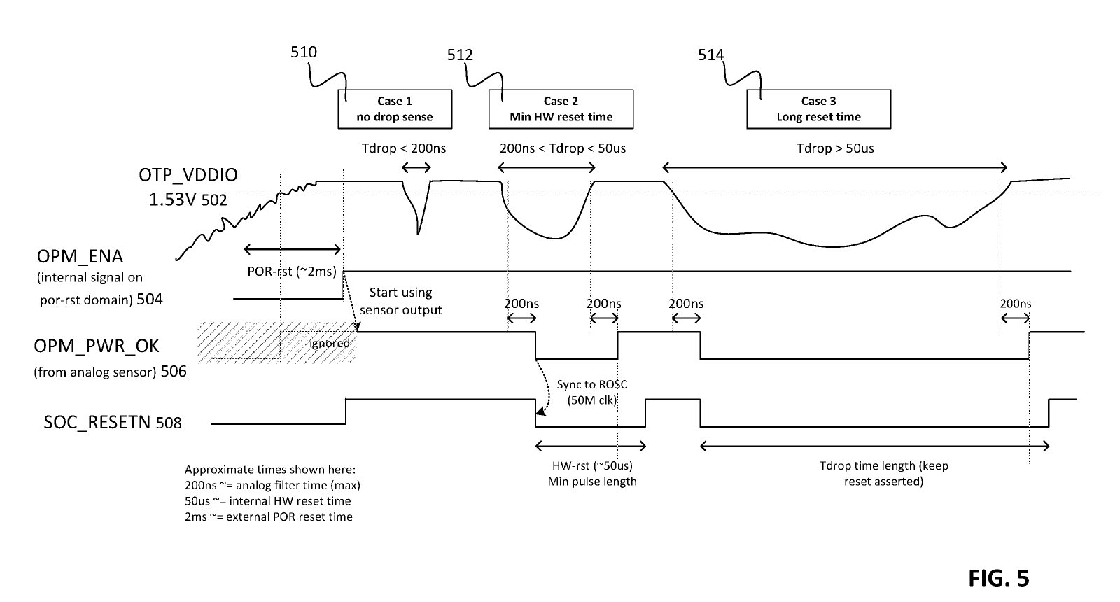

In the previous examples, a drop in the supply voltage beneath the relevant threshold resulted in an instantaneous change to the comparator’s output signal. In an optional configuration, an additional timing requirement may be introduced, such that a comparator’s output signal only changes after the supply voltage has either dropped beneath the first predetermined threshold or raised above the second predetermined threshold for a predetermined duration. FIG. 5 depicts various examples of an OTP memory power drop with such a timing requirement. In this figure, the supply voltage is depicted as 502; the OTP memory power on reset signal is depicted as 504; the comparator output is 506, and the reset signal is 508. Starting from the beginning of the horizontal axis, the supply voltage 502 increases until case 1510 begins, which also represents the power on reset period 504, which in this exemplary configuration is depicted as being approximately 2 ms. At case 1, the supply voltage is at an acceptable level (e.g., at or above the second predetermined threshold), and the comparator output 506 is high (e.g., indicating sufficient supply voltage). The reset signal 508 is high (in this optional configuration, a high reset signal indicates that no reset is to be undertaken, and a low reset signal may be understood as a signal prompt a reset, although this could also be configured in the opposite manner, in which a high reset signal indicates a reset, and a low reset signal indicates no reset). As can be seen, in case 1 508 the supply voltage 502 briefly dips sufficiently below the second predetermined threshold such that the supply voltage would be less than the first predetermined threshold. This does not, however, trigger a change in the comparator output 506 because the drop in the supply voltage is brief and is, in any event, insufficiently long to satisfy a timing requirement, which in this exemplary configuration is 200 ns. Turning to case 2 512, the supply voltage 502 drops beneath the first predetermined threshold for a duration that that is greater than the timing requirement 200 ns. Accordingly, and 200 ns after the supply voltage 502 dropped beneath the first predetermined threshold, the comparator output 506 switches from a high output to a low output, which also triggers the reset signal 508 to drop from a high output to a low output, thereby requiring a reset. The reset lasts approximately 50 µs, during which time the supply voltage increases above the second predetermined threshold, thereby causing the comparator output 506 to switch from low to high. Once the reset is complete, the reset signal 508 also switches from low to high. Of note, this optional configuration depicted in FIG. 5 includes both a lower (e.g., a minimum) time duration and an upper time duration, which are optionally depicted herein as 200 ns and 50 µs respectively. In case 3 514, the supply voltage 514 drops beneath the first predetermined threshold for a period greater than 50 µs, which triggers a longer reset. Another way of understanding this is may simply be that the reset signal may be continuously asserted until the supply voltage increases above the second predetermined threshold. The duration described above may be implemented in any manner. In one exemplary configuration, it may be implemented digitally, such as with a digital controller or counter that introduces the requisite delay for the threshold duration. In this manner, the digital controller may be programmed with a threshold duration and may be configured, for example, to output a signal to enter the second operational mode only when the supply voltage has dropped beneath the first predetermined threshold for the predetermined duration.

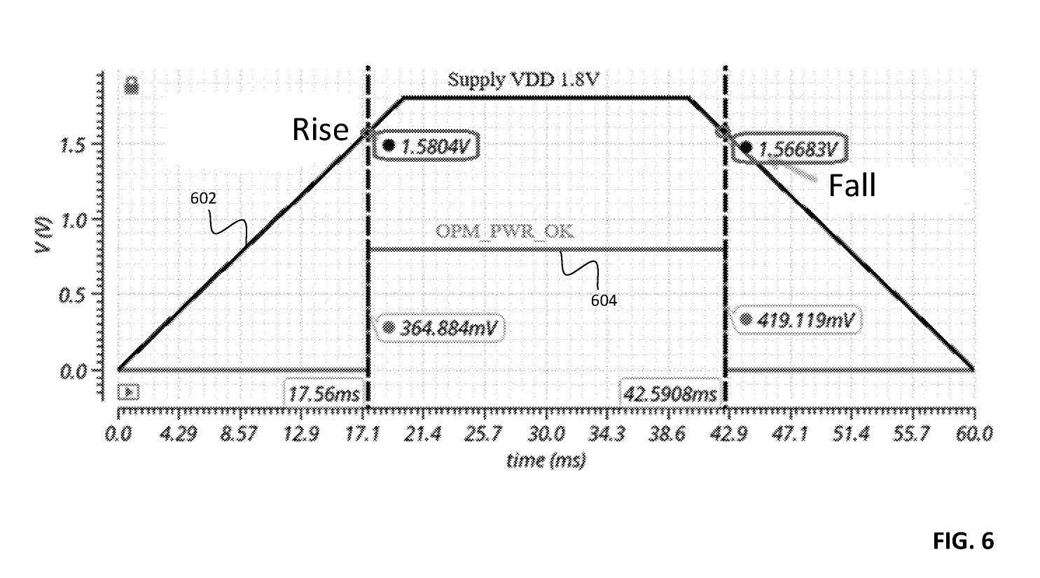

FIG. 6 depicts an additional representation of a change in comparator signal output based on a change in detected supply voltage. In this figure, the supply voltage is depicted as 602, and the comparator output is depicted as 604. Moving from left to right across the horizontal axis, the supply voltage 602 rises until it reaches 1.5804 V, which corresponds to the second predetermined threshold, at which time the comparator output 604 switches from a low signal to a high signal. The supply voltage 605 continues to increase until it stabilizes at approximately 1.8 V. Thereafter, the supply voltage 602 begins to decrease until it drops to 1.56683V, which corresponds to the first predetermined threshold, at which time the comparator output 604 signal switches from a high output to a low output.

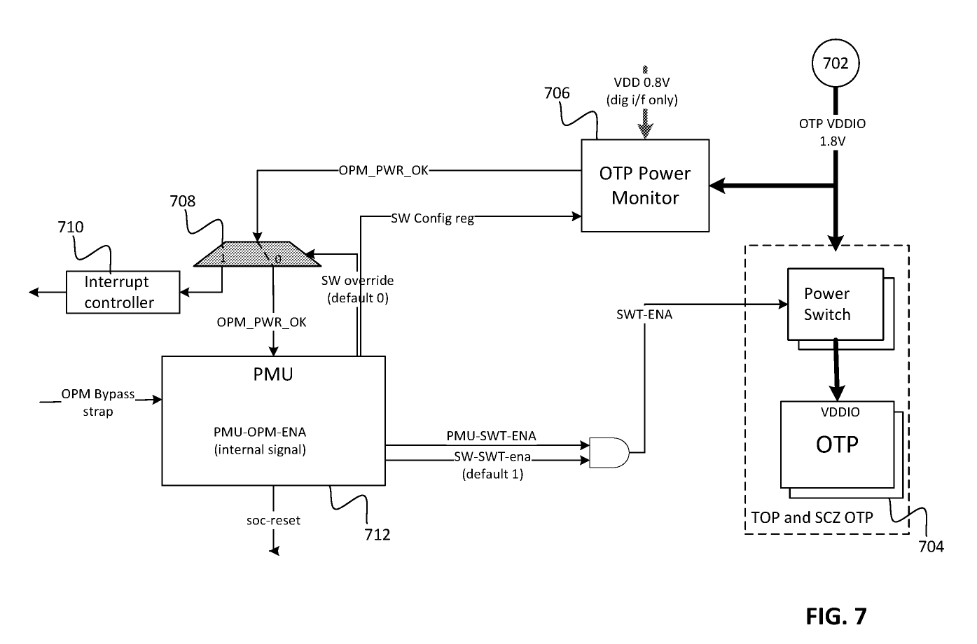

FIG. 7 depicts a system integration of the OTM and the OTP memory. In this configuration, the supply voltage 702 is connected to the OTP memory 704, and the OTM 706 detects the supply voltage 702 from the connection between the supply voltage 702 and the OTP memory 704. The OTM 706 outputs a signal indicating whether the power is satisfactory, which may be output to a multiplexer 708. The multiplexer 708 may be configured to output to either an interrupt controller 710 or a power management unit 712, such as based on a software override signal generated and sent by the power management unit 712. In this manner, the power management unit may generate or send a reset signal to the OTP memory 704 or may override the generation of a reset signal by changing an output of the multiplexer 708. It is specifically noted that this is one of many possible configurations for integration of the concepts described herein with an additional device, and it should not be considered limiting.

The concept as disclosed herein may be configured as a device, which may include a one-time programmable memory, which may be electrically conductively connected to a voltage source. The device may further include a voltage monitor, which may be electrically conductively connected to the voltage source. The voltage monitor may be configured to detect a voltage of the voltage source; cause the one-time programmable memory to operate according to a first operational mode when the detected voltage is above a first predetermined threshold; and cause the one-time programmable memory to operate according to a second operational mode when the detected voltage is below a second predetermined threshold. It is expressly noted that the first operational mode may be understood as a normal operating mode, and the second operational mode may be understood as a mode corresponding to insufficient supply voltage, which may be indicative of an attack and, as disclosed herein, may result in generation of a reset signal to reset the underlying chip.

The voltage monitor may be configured to cause the one-time programmable memory to operate according to the second operational mode in that the voltage monitor may send a reset signal to reset the one-time programmable memory. This may be performed immediately upon the supply voltage following beneath the first predetermined threshold, or this may optionally be performed following the supply voltage following beneath the first predetermined threshold for a predetermined duration.

The voltage monitor may include a reference voltage generator, which may be configured to generate a reference voltage. The voltage monitor may include a comparator, which may be configured to compare a voltage of the voltage source to the reference voltage. Based on this comparison, the voltage monitor may be configured to output a first signal when the voltage of the voltage source is greater than the first predetermined threshold, and output a second signal, different from the first signal, when the voltage of the voltage source is less than the second predetermined threshold. In this manner, the first predetermined threshold may be understood as a predetermined voltage greater than the reference voltage, and the second predetermined threshold may be understood as a predetermined voltage less than the reference voltage.

The voltage monitor may be configured to cause the one-time programmable memory to operate according to the first operational mode when the comparator outputs the first signal and to cause the one-time programmable memory to operate according to the second operational mode when the comparator outputs the second signal. In this manner, the first signal is associated with a normal operating mode, and the second signal is associated with an operating mode that suggest insufficient supply voltage and may suggest an attack.

In an optional configuration, the voltage monitor may be configured to cause the one-time programmable memory to operate according to the second operational mode when the comparator outputs the second signal for a duration that is greater than a threshold duration. In this manner, a threshold duration may be introduced which may prevent the device from entering the second operational mode based on a very brief reduction in supply voltage. This threshold duration therefore has the effect of stabilizing the system where brief reductions in supply voltages occur. Despite the brief reduction in threshold supply, the introduction of a threshold duration, provided that the duration is tailored to the requirements of the device, is not expected to increase the vulnerability of the device, as the threshold duration may be, for example, shorter than the duration required to gain access to secure information and the device through an attack arising out of low supply voltage. The voltage monitor may be configured to cause the one-time programmable memory to operate according to the first operational mode when the comparator outputs the first signal or when the comparator outputs the second signal for a duration that is less than the threshold duration. In this manner, changes to the output signal (corresponding to the first signal or the second signal) that are shorter than the threshold duration, may not affect the operational mode.

The detected voltage of the voltage source may be a first detected voltage, and the reference voltage may be a first reference voltage. In this manner, the second predetermined threshold may be greater than the first predetermined threshold. As such, and after the voltage monitor causes the one-time programmable memory to operate according to the second operational mode, the voltage monitor may be further configured to detect a second detected voltage of the voltage source, to cause the one-time programmable memory to operate according to the first operational mode when the second detected voltage is above the second predetermined threshold, and to cause the one-time programmable memory to operate according to the second operational mode when the second detected voltage is less than the first predetermined threshold. In other words, the voltage monitor may be configured to operate using hysteresis, such that the first operational mode has a lower boundary and the second operational mode has an upper boundary, and wherein these boundaries are distinct and separate from one another. The introduction of hysteresis may improve stability of the voltage monitor’s function by prohibiting an output signal of the voltage monitor from rapidly oscillating due to a detected voltage close to a predetermined threshold.

Throughout this disclosure, a voltage source and a reference voltage source are disclosed. To the extent not otherwise disclosed herein, these may be implemented in an SOC or chip that also includes the device described herein. Alternatively, they may be implemented in different chips, such as on one or more chips or SOCs that are separate from a chip on which the device is implemented.

During use, the state of the one-time programmable memory may change between being under attack and not being under attack. In this manner, the device may be configured to switch between the first operational mode and the second operational mode, perhaps multiple times. For example, the device may be configured to detect that the voltage of the voltage source is below the predetermined threshold and operate according to the second operational mode, subsequently detect that the voltage of the voltage source is above the predetermined threshold and operate according to the first operational mode, and then subsequently determine that the voltage of the voltage source is below the predetermined threshold and operate according to the second operational mode.

The device as disclosed herein, including the voltage monitor, may be optionally configured as a system on chip. The device may be configured as part of a larger form factor, such as, but not limited to, a radar device, a light detection and ranging (LiDAR) device, a vehicle, a computer, a laptop computer, a tablet computer, a smartphone, a wireless access point, or an internet of things device.

Further aspects of the disclosure will be described by way of example:

In Example 1, a device includes a one-time programmable memory, electrically conductively connected to a voltage source; and a voltage monitor, electrically conductively connected to the voltage source, and configured to: detect a voltage of the voltage source; cause the one-time programmable memory to operate according to a first operational mode when the detected voltage is above a first predetermined threshold; and cause the one-time programmable memory to operate according to a second operational mode when the detected voltage is below a second predetermined threshold.

In Example 2, the device of Example 1, wherein the voltage monitor causing the one-time programmable memory to operate according to the second operational mode includes the voltage monitor sending a reset signal to reset the one-time programmable memory; and wherein the voltage monitor causing the one-time programmable memory to operate according to the first operational mode includes the voltage monitor sending no reset signal.

In Example 3, the device of Example 1 or 2, wherein the voltage monitor includes: a reference voltage generator, configured to generate a reference voltage; and a comparator, configured to: compare a voltage of the voltage source to the reference voltage; output a first signal when the voltage of the voltage source is greater than the first predetermined threshold; and output a second signal, different from the first signal, when the voltage of the voltage source is less than the second predetermined threshold; and wherein the first predetermined threshold is a predetermined voltage greater than the reference voltage, and wherein the second predetermined threshold is a predetermined voltage less than the reference voltage.

In Example 4, the device of any one of Examples 1 to 3, wherein the voltage monitor is configured to cause the one-time programmable memory to operate according to the first operational mode when the comparator outputs the first signal and to cause the one-time programmable memory to operate according to the second operational mode when the comparator outputs the second signal.

In Example 5, the device of any one of Examples 1 to 4, wherein the voltage monitor is configured to cause the one-time programmable memory to operate according to the second operational mode when the comparator outputs the second signal for a duration that is greater than a threshold duration; and wherein the voltage monitor is configured to cause the one-time programmable memory to operate according to the first operational mode when the comparator outputs the first signal or when the comparator outputs the second signal for a duration that is less than the threshold duration.

In Example 6, the device of any one of Examples 1 to 5, wherein the detected voltage of the voltage source is a first detected voltage, and the reference voltage is a first reference voltage; and wherein the second predetermined threshold is greater than the first predetermined threshold; wherein after the voltage monitor causes the one-time programmable memory to operate according to the second operational mode, the voltage monitor is further configured to detect a second detected voltage of the voltage source; to cause the one-time programmable memory to operate according to the first operational mode when the second detected voltage is above the first predetermined threshold; and to cause the one-time programmable memory to operate according to the second operational mode when the second detected voltage is less than the first predetermined threshold.

In Example 7, the device of any one of Examples 1 to 6, wherein the device is configured as a system on chip.

In Example 8, the device of any one of Examples 1 to 7, wherein the device is configured as a portion of a radar device, LiDAR device, vehicle, computer, laptop computer, tablet computer, smartphone, wireless access point, or internet of things device.

In Example 9, the device of any one of Examples 1 to 8, wherein the voltage monitor being configured to detect a voltage of the voltage source includes the voltage monitor being configured to detect exclusively the voltage of the voltage source.

In Example 10, a device including: a one-time programmable memory, electrically conductively connected to a voltage source; and a voltage monitor, electrically conductively connected to the voltage source; wherein the voltage monitor is for: detecting a voltage of the voltage source; causing the one-time programmable memory to operate according to a first operational mode when the detected voltage is above a first predetermined threshold; and causing the one-time programmable memory to operate according to a second operational mode when the detected voltage is below a second predetermined threshold.

In Example 11, the device of Example 10, wherein the voltage monitor being for causing the one-time programmable memory to operate according to the second operational mode includes the voltage monitor being for sending a reset signal to reset the one-time programmable memory; and wherein the voltage monitor being for causing the one-time programmable memory to operate according to the first operational mode includes the voltage monitor being for sending no reset signal.

In Example 12, the device of Example 10 or 11, wherein the voltage monitor includes: a reference voltage generator for generating a reference voltage; and a comparator for: comparing a voltage of the voltage source to the reference voltage; outputting a first signal when the voltage of the voltage source is greater than the first predetermined threshold; and outputting a second signal, different from the first signal, when the voltage of the voltage source is less than the second predetermined threshold; and wherein the first predetermined threshold is a predetermined voltage greater than the reference voltage, and wherein the second predetermined threshold is a predetermined voltage less than the reference voltage.

In Example 13, the device of any one of Examples 10 to 12, wherein the voltage monitor is for causing the one-time programmable memory to operate according to the first operational mode when the comparator outputs the first signal and for causing the one-time programmable memory to operate according to the second operational mode when the comparator outputs the second signal.

In Example 14, the device of any one of Examples 10 to 13, wherein the voltage monitor is for causing the one-time programmable memory to operate according to the second operational mode when the comparator outputs the second signal for a duration that is greater than a threshold duration; and wherein the voltage monitor is for causing the one-time programmable memory to operate according to the first operational mode when the comparator outputs the first signal or when the comparator outputs the second signal for a duration that is less than the threshold duration.

In Example 15, the device of any one of Examples 10 to 14, wherein the detected voltage of the voltage source is a first detected voltage, and the reference voltage is a first reference voltage; and wherein the second predetermined threshold is greater than the first predetermined threshold; wherein after the voltage monitor causes the one-time programmable memory to operate according to the second operational mode, the voltage monitor is further for detecting a second detected voltage of the voltage source; for causing the one-time programmable memory to operate according to the first operational mode when the second detected voltage is above the first predetermined threshold; and for causing the one-time programmable memory to operate according to the second operational mode when the second detected voltage is less than the first predetermined threshold.

In Example 16, the device of any one of Examples 10 to 15, wherein the device is configured as a system on chip.

In Example 17, the device of any one of Examples 10 to 16, wherein the device is configured as a portion of a radar device, LiDAR device, vehicle, computer, laptop computer, tablet computer, smartphone, wireless access point, or internet of things device.

In Example 18, the device of any one of Examples 10 to 17, wherein the voltage monitor being for detecting a voltage of the voltage source includes the voltage monitor being for detecting exclusively the voltage of the voltage source.

In Example 19, a method of voltage monitoring of a one-time programmable memory, including: detecting in a voltage monitor a voltage of a voltage source that is also connected as a supply voltage to a one-time programmable memory; causing the one-time programmable memory to operate according to a first operational mode when the detected voltage is above a first predetermined threshold; and causing the one-time programmable memory to operate according to a second operational mode when the detected voltage is below a second predetermined threshold.

In Example 20, the method of Example 19, wherein causing the one-time programmable memory to operate according to the second operational mode includes sending a reset signal to reset the one-time programmable memory; and wherein causing the one-time programmable memory to operate according to the first operational mode includes sending no reset signal.

In Example 21, the method of Example 19 or 20, further including: comparing a voltage of the voltage source to a reference voltage; outputting a first signal when the voltage of the voltage source is greater than the first predetermined threshold; and outputting a second signal, different from the first signal, when the voltage of the voltage source is less than the second predetermined threshold; and wherein the first predetermined threshold is a predetermined voltage greater than the reference voltage, and wherein the second predetermined threshold is a predetermined voltage less than the reference voltage.

In Example 22, the method of any one of Examples 19 to 21, further including causing the one-time programmable memory to operate according to the first operational mode when the comparator outputs the first signal and cause the one-time programmable memory to operate according to the second operational mode when the comparator outputs the second signal.

In Example 23, the method of any one of Examples 19 to 22, further including causing the one-time programmable memory to operate according to the second operational mode when the comparator outputs the second signal for a duration that is greater than a threshold duration; and causing the one-time programmable memory to operate according to the first operational mode when the comparator outputs the first signal or when the comparator outputs the second signal for a duration that is less than the threshold duration.

In Example 24, the method of any one of Examples 19 to 23, wherein the detected voltage of the voltage source is a first detected voltage, and the reference voltage is a first reference voltage; and wherein the second predetermined threshold is greater than the first predetermined threshold; further including detecting a second detected voltage of the voltage source after the one-time programmable memory is caused to operate according to the second operational mode; causing the one-time programmable memory to operate according to the first operational mode when the second detected voltage is above the first predetermined threshold; and causing the one-time programmable memory to operate according to the second operational mode when the second detected voltage is less than the first predetermined threshold.

In Example 25, the method of any one of Examples 19 to 24, wherein the detecting the voltage of the voltage source includes detecting exclusively the voltage of the voltage source.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all Examples included herein.

1. A device comprising:
a one-time programmable memory, electrically conductively connected to a voltage source; and
a voltage monitor, electrically conductively connected to the voltage source, and configured to:
detect a voltage of the voltage source;
cause the one-time programmable memory to operate according to a first operational mode when the detected voltage is above a first predetermined threshold; and
cause the one-time programmable memory to operate according to a second operational mode when the detected voltage is below a second predetermined threshold.

2. The device of claim 1, wherein the voltage monitor causing the one-time programmable memory to operate according to the second operational mode comprises the voltage monitor sending a reset signal to reset the one-time programmable memory; and wherein the voltage monitor causing the one-time programmable memory to operate according to the first operational mode comprises the voltage monitor sending no reset signal.

3. The device of claim 2, wherein the voltage monitor comprises:
a reference voltage generator, configured to generate a reference voltage; and
a comparator, configured to:
compare a voltage of the voltage source to the reference voltage;
output a first signal when the voltage of the voltage source is greater than the first predetermined threshold; and
output a second signal, different from the first signal, when the voltage of the voltage source is less than the second predetermined threshold; and
wherein the first predetermined threshold is a predetermined voltage greater than the reference voltage, and wherein the second predetermined threshold is a predetermined voltage less than the reference voltage.

4. The device of claim 3, wherein the voltage monitor is configured to cause the one-time programmable memory to operate according to the first operational mode when the comparator outputs the first signal and to cause the one-time programmable memory to operate according to the second operational mode when the comparator outputs the second signal.

5. The device of claim 2, wherein the voltage monitor is configured to cause the one-time programmable memory to operate according to the second operational mode when the comparator outputs the second signal for a duration that is greater than a threshold duration; and wherein the voltage monitor is configured to cause the one-time programmable memory to operate according to the first operational mode when the comparator outputs the first signal or when the comparator outputs the second signal for a duration that is less than the threshold duration.

6. The device of claim 1, wherein the detected voltage of the voltage source is a first detected voltage, and the reference voltage is a first reference voltage; and
wherein the second predetermined threshold is greater than the first predetermined threshold; wherein after the voltage monitor causes the one-time programmable memory to operate according to the second operational mode, the voltage monitor is further configured to detect a second detected voltage of the voltage source; to cause the one-time programmable memory to operate according to the first operational mode when the second detected voltage is above the first predetermined threshold; and to cause the one-time programmable memory to operate according to the second operational mode when the second detected voltage is less than the first predetermined threshold.

7. The device of claim 1, wherein the device is configured as a system on chip.

8. The device of claim 1, wherein the device is configured as a portion of a radar device, LiDAR device, vehicle, computer, laptop computer, tablet computer, smartphone, wireless access point, or internet of things device.

9. The device of claim 1, wherein the voltage monitor being configured to detect a voltage of the voltage source comprises the voltage monitor being configured to detect exclusively the voltage of the voltage source.

10. The device of claim 1, wherein the voltage monitor is further configured to:
detect that the voltage of the voltage source is below the predetermined threshold and operate according to the second operational mode, subsequently detect that the voltage of the voltage source is above the predetermined threshold and operate according to the first operational mode, and then subsequently determine that the voltage of the voltage source is below the predetermined threshold and operate according to the second operational mode.

11. A method of voltage monitoring of a one-time programmable memory, comprising:
detecting in a voltage monitor a voltage of a voltage source that is also connected as a supply voltage to a one-time programmable memory;
causing the one-time programmable memory to operate according to a first operational mode when the detected voltage is above a first predetermined threshold; and
causing the one-time programmable memory to operate according to a second operational mode when the detected voltage is below a second predetermined threshold.

12. The method of claim 11, wherein causing the one-time programmable memory to operate according to the second operational mode comprises sending a reset signal to reset the one-time programmable memory; and wherein causing the one-time programmable memory to operate according to the first operational mode comprises sending no reset signal.

13. The method of claim 12, further comprising:
comparing a voltage of the voltage source to a reference voltage;
outputting a first signal when the voltage of the voltage source is greater than the first predetermined threshold; and
outputting a second signal, different from the first signal, when the voltage of the voltage source is less than the second predetermined threshold; and
wherein the first predetermined threshold is a predetermined voltage greater than the reference voltage, and wherein the second predetermined threshold is a predetermined voltage less than the reference voltage.

14. The method of claim 13, further comprising causing the one-time programmable memory to operate according to the first operational mode when the comparator outputs the first signal and cause the one-time programmable memory to operate according to the second operational mode when the comparator outputs the second signal.

15. The method of claim 14, further comprising causing the one-time programmable memory to operate according to the second operational mode when the comparator outputs the second signal for a duration that is greater than a threshold duration; and causing the one-time programmable memory to operate according to the first operational mode when the comparator outputs the first signal or when the comparator outputs the second signal for a duration that is less than the threshold duration.

16. The method of claim 11, wherein the detected voltage of the voltage source is a first detected voltage, and the reference voltage is a first reference voltage; and
wherein the second predetermined threshold is greater than the first predetermined threshold; further comprising detecting a second detected voltage of the voltage source after the one-time programmable memory is caused to operate according to the second operational mode; causing the one-time programmable memory to operate according to the first operational mode when the second detected voltage is above the first predetermined threshold; and causing the one-time programmable memory to operate according to the second operational mode when the second detected voltage is less than the first predetermined threshold.

17. The method of claim 11, wherein the detecting the voltage of the voltage source comprises detecting exclusively the voltage of the voltage source.

18. The method of claim 11, wherein the operation according to the second operational mode is in response to injection of a low voltage to the one-time programmable memory corresponding to an external intervention, such as by a hacker.
